(19) United States
(12) Patent Application Publication
(10) Pub. No.: US 2013/0199805 A1
(43) Pub. Date: Aug. 8, 2013

(54) FOAM BUN FIRE SUPPRESSION SYSTEM

(71) Applicant: FLEXIBLE FOAM PRODUCTS, INC., Spencerville, OH (US)

(72) Inventor: KEVIN GASKILL, SPENCERVILLE, OH (US)

(73) Assignee: FLEXIBLE FOAM PRODUCTS, INC., SPENCERVILLE, OH (US)

(21) Appl. No.: 13/754,129

(22) Filed: Jan. 30, 2013

Related U.S. Application Data
(60) Provisional application No. 61/594,651, filed on Feb. 3, 2012.

(51) Int. Cl. A62C 8/00; A62C 3/06

(52) U.S. Cl. CPC A62C 8/00; A62C 3/06
USPC 169/46; 169/70

(57) ABSTRACT

The present disclosure provides a bun fire suppression system that includes a wand, a valve, and a hose. The wand is configured to pierce into a foam bun. The wand further includes a plurality of holes extending from the hollow portion inside the wand to the exterior of the wand. The valve is coupled to the wand and is in fluid communication with the hollow portion of the wand. The valve includes a shut-off that selectively stops and releases water flow from the valve to the hollow portion of the wand. The hose is coupled to a water source to direct water to the wand.

### RELATED APPLICATIONS

The present application is related to and claims priority to U.S. Provisional Patent Application Ser. No. 61/594,651, filed on Feb. 3, 2012, entitled “Foam Bun Fire Suppression System.” The subject matter disclosed in that provisional application is hereby expressly incorporated into the present application.

### TECHNICAL FIELD AND SUMMARY

The present disclosure is related to an apparatus and method fire suppression system to dowse internally combusting foam buns.

Polyurethane foam is a very common foam material used extensively from seat cushioning to packaging materials. It is generally a resilient cellular material making it ideal for padding applications, since it returns to its original shape after pressure on it has been relieved.

Despite polyurethane foam's familiar widespread use, it is a relatively dangerous product to manufacture. Polyurethane foam is made by mixing several chemicals, such as TDI and polyol with water and other additives, forcing the resulting material through a die and then allowing it to expand. This process results in a long, hot “bun” of foam that is about 6 feet wide, about 5 feet tall, and about 200 feet long. Trying to cut or otherwise process foam while it is still hot makes it shrink. As a consequence, once a 200 foot long “bun” of foam is made, it is left to cool for about 16 to 24 hours in what is called a “bun room.” This room is essentially a large football field-sized warehouse that receives the bun off the line. With an overhead crane the buns are stacked and allowed to cool until ready to move to another section where the foam is cut and packaged. If the chemicals used to make the foam are not formulated in a very precise manner, however, the resulting foam material may ignite. Moreover, and more problematic, the combustion typically occurs inside the foam bun, not at its surface. This means it may not be apparent when the foam begins burning.

Burning foam presents complex problems. First, the foam is inherently flammable requiring care when handling. Second, and as a consequence, the large amount of foam stored in one location makes any fire an emergency situation. Third, the noxious chemicals released when foam burns extend the danger to not just the storage facility, but the surrounding environment as well. And lastly, the fact that combustion inside the foam is difficult to detect in the first place, makes detecting the precise location of the fire difficult.

There are typically no exposed flames, so the question becomes where exactly inside the 200 foot long bun of foam is it burning? The bun is too large to be transported to another section of the facility, or thrown outside. As a consequence, it must be dealt with inside the bun room where all the other foam buns are housed as well.

Further complicating this circumstance is that if the foam begins to burn internally, it typically smolders. This is because the fire lacks oxygen. Of course one way to access the smoldering foam is by cutting through the bun. But cutting the foam is akin to injecting a large fuel source into a fire. This oxygen-starved fire might create a rapid spread. Moreover the bun may be sitting on a conveyor belt, the floor, or another bun—meaning it can only be accessed from the side or the top. The top, however, may not be an option, because if one were to stand on an internally burning foam bun, the fire may create a weak spot causing that person or object to fall into the burning core.

An illustrative embodiment of the present disclosure provides a bun fire suppression system that comprises a wand, a valve, and a hose. The wand includes shaft and end portions, as well as a hollow portion disposed through the shaft portion. The wand is configured to pierce into the foam bun. The wand further includes a plurality of holes extending from the hollow portion inside the wand to the exterior of the wand. The plurality of holes in the wand are configured to direct water out and away from the wand in a plurality of directions. The valve is coupled to the wand and is in fluid communication with the hollow portion of the wand. The valve includes a shut-off that selectively stops and releases water flow from the valve to the hollow portion of the wand. The hose is coupled to the valve opposite the wand. The hose is also configured to couple to a water source and direct water to the valve.

In the above and other embodiments, the bun fire suppression system may further comprise: the valve being a ball valve; the wand being configured to be inserted into foam; the wand may be about 80 inches in length; the plurality of holes in the wand being distributed along the wand's shaft; the hose being configured to receive pressurized water up to the valve while the valve is shut off such that when the valve is opened atmosphere inside the hollow portion of the wand is pushed exterior of the wand by the water; a plurality of wands, each coupled to a separate valve and hose, and all hoses being coupled to the water source so each wand is configured to selectively spray water; the plurality of holes in the wand being configured to expel water from a peripheral circumference of the wand; the wand being configured to thread onto the valve, and the valve also being configured to thread onto the hose; a hose shut-off spaced apart from the valve shut-off; the plurality of holes being each smaller in diameter than the hollow portion's cross-section; the hose being fluidly coupled to a portable water source; and the end of the wand being needle-tipped.

Another illustrative embodiment of the present disclosure provides a method of dousing an interior portion of a burning foam bun, the method comprises the steps of: providing a fire suppression system that includes a wand comprising shaft and end portions, and having a hollow portion disposed through the shaft portion, wherein the wand is configured to pierce into a foam bun, wherein the wand further includes a plurality of holes extending from the hollow portion inside the wand to the exterior of the wand, wherein the plurality of holes in the wand are configured to direct water out and away from the wand in a plurality of directions, a valve coupled to the wand and in fluid communication with the hollow portion of the wand, wherein the valve includes a shut-off that selectively stops and releases water flow from the valve to the hollow portion of the wand; and a hose coupled to the valve opposite the wand, wherein the hose is configured to also couple to a water source and direct water to the valve; inserting the shaft of the wand into the interior of the bun; opening the valve; and allowing water to spray through the plurality of holes in the wand, away from the wand, and in multiple directions into the foam bun.

Additional features and advantages of the fire suppression system will become apparent to those skilled in the art upon consideration of the following detailed description of the illustrated embodiment exemplifying the best mode of carrying out the fire suppression system as presently perceived.

### BRIEF DESCRIPTION OF DRAWINGS

The present disclosure will be described hereafter with reference to the attached drawings which are given as non-limiting examples only, in which:

FIG. 1 is a side-perspective and partial cross-sectional view of a fire suppression system in operation by spraying water into a foam bun by a fire fighter;

FIG. 2 is a perspective view showing multiple fire fighters, each injecting a bun with separate fire suppression wands;

FIG. 3 is a perspective view of the fire suppression system;

FIG. 4 is an exploded view of the fire suppression system of FIG. 3;

FIG. 5 is a partial detail-sectional view of a wand portion of the fire suppression system; and

FIG. 6 is a perspective view of an illustrative bun room which houses a long foam bun.

Corresponding reference characters indicate corresponding parts throughout the several views. The exemplification set out herein illustrates embodiments of the foam bun fire suppression system, and such exemplification is not to be construed as limiting the scope of the foam bun fire suppression system in any manner.

### DETAILED DESCRIPTION OF THE DRAWINGS

An embodiment of the present disclosure provides a foam bun fire suppression system and method. The system includes a large needle-tipped hollow wand with holes distributed through its sides that can be jammed into the foam. The wand then sprays water in multiple directions to dowse the bun's burning core. Illustratively, the wand may be about 80 inches long with its plurality of holes disposed along the length of its shaft. Once the wand is jammed inside the foam bun, an illustrative ball valve positioned between the wand and a water source is activated allowing water to enter the hollow shaft. That water then sprays from each of the holes in multiple directions throughout the foam. The water dowses the internally burning foam if it is in proximity to the wand. If the location of the combustion is not precisely known, the wand can be withdrawn from the foam and then reinserted into another section and dowsed again. This procedure may be repeated along the entire length of the foam if needed for both extinguishing the internal combustion, as well as suppressing a fuel source by dowsing the foam itself.

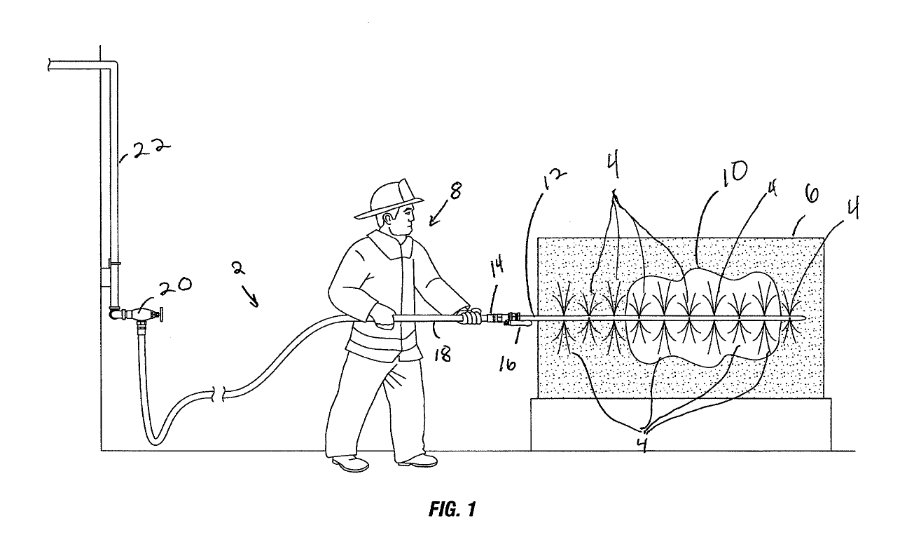

A side-perspective and partial cross-sectional view of fire suppression system 2 in operation by spraying water 4 into a foam bun 6 by a fire fighter 8 is shown in FIG. 1. The intent of system 2 is to inject water into the interior of bun 6 if its interior begins burning, such as that indicated by reference numeral 10. As previously discussed, it is important to extinguish an internally burning foam bun before that combustion is exposed to air where it could explode. Suppression system 2 illustratively comprises a wand 12 that may be of desired thickness and is configured to pierce into foam bun 6. In an illustrative embodiment, wand 12 may be about 80 inches long. Wand 12 includes a hollow center with holes located periodically along its length to allow water to expel from it in multiple directions and dowse the fire. Attached to wand 12 is a valve 14 with a shut off handle 16 intended to stop or release the water flow. Attached to valve 14 illustratively opposite wand 12 is hose 18. In an illustrative embodiment, hose 18 is constantly filled with water so that when shut off handle 16 opens, water is immediately forced through the wand and into bun 6. Because oxygen is a fuel in this circumstance, it is not desirable for water pressure to exist a substantial distance behind a quantity of air in hose 18. In this circumstance, water pushes through the hose, but pushes that air through first which feeds the burning bun. In this embodiment, water fills hose 18 specifically when handle 16 is shut off so there is no available oxygen to feed the fire.

As shown, hose 18 attaches to another valve 20 opposite valve 14. Valve 20, illustratively a ball valve, is configured to shut off or release water to or from suppression system 2. Under circumstances where water is needed in other parts of the facility and internally combustible foam buns are not an issue, shutting off water supply to system 2 via valve 20 may be useful. Additionally, the water supply may be shut off at valve 20 in order to maintain or replace components of fire suppression system 2, such as the hose or wand. In this illustrative embodiment, valve 20 is attached to piping 22 which is in fluid communication to a water or fluid supply from an adjacent or remote location. In certain circumstances it may be desirable to draw water from a remote location so that the water supply for such systems as sprinklers in the bun room remains unimpeded and fully supplied of water. This allows the fire suppression system 2 to have its own water supply to dowse any burning foam buns at the same time.

In one instance the fluid supply is separated from the fluid supply to the bun room. A water pipe may extend from the remote fluid supply to the bun room. Illustratively a second shut off valve is located between the fluid supply pipe and a wand hose. Therefore, if water is needed for other reasons, it can be cut off to the fire suppression system. The wand hose may be positioned between the two valves and is of sufficient length to allow the wand to engage various locations of the foam bun. The wand's ball valve is positioned between the wand hose and the wand itself to selectively allow water to move to the wand. In an embodiment, water is constantly maintained in the wand hose right up to the wand valve. This is because oxygen is a dangerous fuel for the internally smoldering foam. Accordingly, it is desirable to have as little air contact with the smoldering foam as possible while the wand is being inserted and turned on. If the water flow sits too far behind the handle grip of the wand before it starts flowing, the water will push any air in front of it directly into the smoldering bun, thereby potentially creating a further hazard. Having water specifically located at the start of the wand reduces such a risk.

It is appreciated that a water supply pipe, drawing water from either the bun room water supply or a remote water supply, provides water to a plurality of wand stations along the length of the bun room adjacent the longitudinal axis of the bun. In an illustrative embodiment, one wand station may comprise two or more wands attached to two or more wand hoses that are themselves attached to the water supply. This allows multiple personnel, particularly fire fighters, to each obtain a wand along the length of the bun and simultaneously inject it with the wand and dowse it with water.

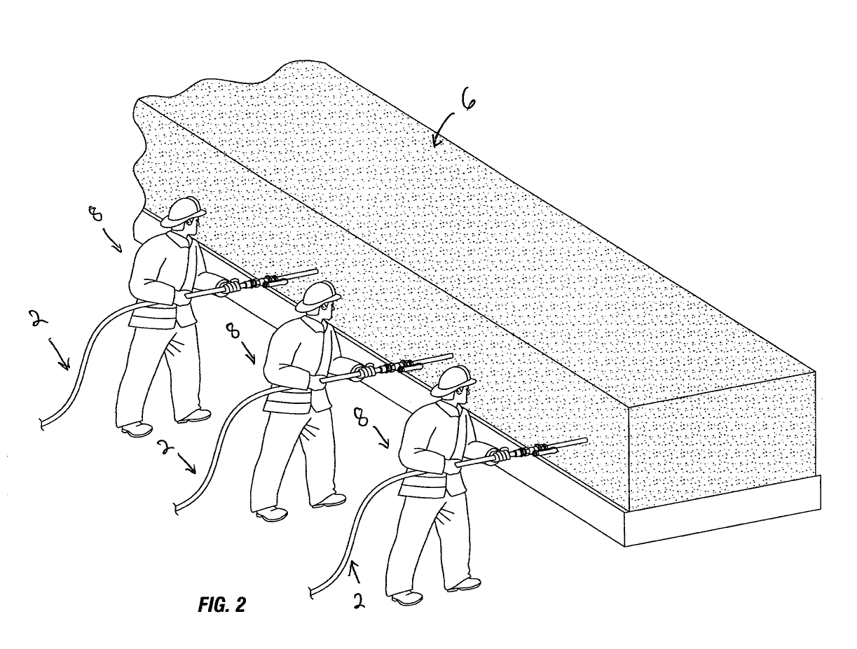

A perspective view showing multiple fire fighters 8, each injecting bun 6 with a separate fire suppression system 2 is shown in FIG. 2. This view helps illustrate the scale to which these foam buns 6 are made. Because they may be 5 feet wide and several feet high, dowsing an internal fire can be difficult. This is compounded by the fact that these buns may be 100 feet long. Having multiple wands operated by multiple fire fighters can dowse this large bun much more quickly. In addition, one of the inherent problems with fighting a bun fire is that the location of the internal combustion may not be readily ascertainable, unless the bun is cut open. But as previously discussed, cutting the bun open is supplying its inside with oxygen. Such a fuel source is especially dangerous with foam buns, because with its inside burning, it is starving oxygen.

The view in FIG. 2 also shows operation of fire suppression system 2 from the bun 6′s side. It is contemplated that the wands may pierce through any side of bun 6 to dowse it. It is unadvisable, however, to inject bun 6 from the top if it requires a fire fighter to stand on top of it. This is because the fire could make the top surface of the bun weak and, if someone were to stand on the area where the combustion exists, that person could fall into the bun. This may seem common sense, but as previously discussed, an internally burning foam core is initially difficult to identify. The top of the bun may deceptively appear stable, when in fact it is not. This is why, as shown in FIG. 2, the wand pierces the foam from the side.

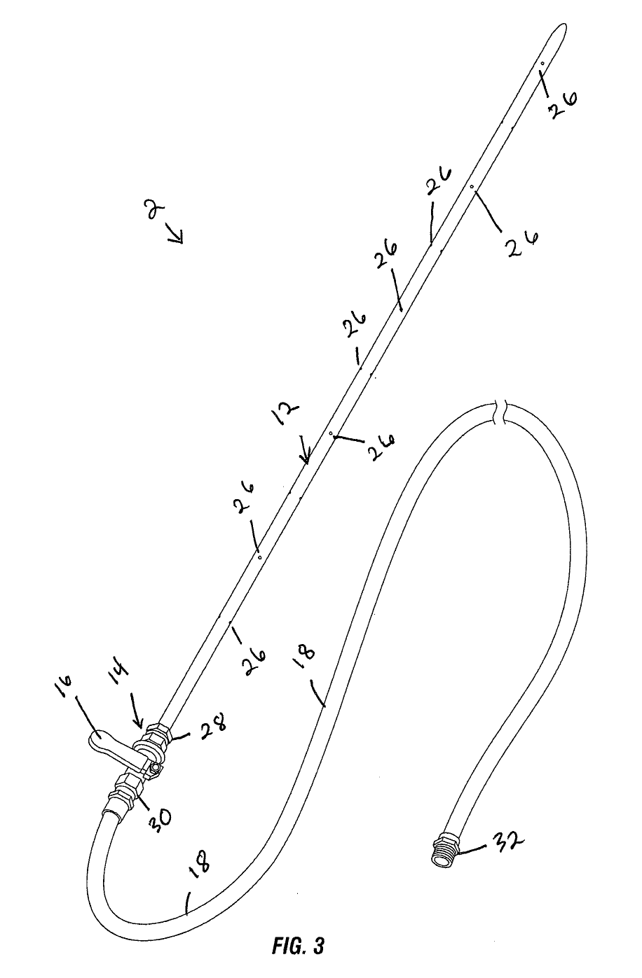

A perspective view of fire suppression system 2 is shown in FIG. 3. This view shows wand 12, valve 14 with shut off handle 16, and hose 18. Holes 26 are also shown dispersed throughout the surface of wand 12. Water is configured to travel through wand 12 and exit from holes 26 providing a multi-directional spray of water. In an embodiment, the spray of water may expel around the circumference of wand 12. Wand 12 may also include a coupling 28 configured to engage and secure to valve 14. Both valve 14 and wand 12 are in fluid communication with each other. Shut off handle 16 shown in this view is in the off position. Illustratively at the opposite end of valve 14 from wand 12 is a coupling 30 configured to attach to hose 18. It is appreciated that this coupling may be a threaded coupling to secure the two components together. Another coupling 32 at the opposite end of hose 18 is configured to attach to the fluid source or valve 20 such as that shown in FIG. 1.

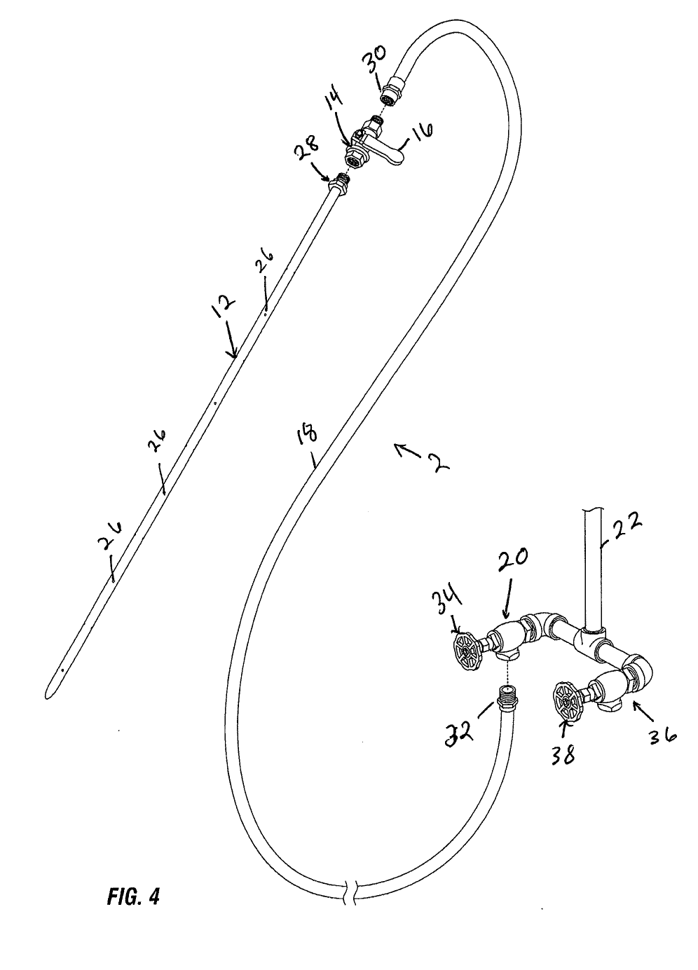

An exploded view of fire suppression system 2 is shown in FIG. 4. This view shows coupling 28 of wand 12 to be an illustrative male thread that threads onto a corresponding receptacle in valve 14. This view also shows holes 26 disposed throughout the length of wand 12. Coupling 30 similarly threads onto valve 14 to connect hose 18. Coupling 32 is likewise threaded and is shown connectable to valve 20 which itself includes shut off knob 34. As illustratively shown, a second valve 36 and shut off knob 38 is configured to attach to a second fire suppression system 2. This allows a single pipe, such as pipe 22, to feed water into two separate fire suppression systems 2 so that multiple fire fighters can inject multiple wands 12 into bun 6 at different locations simultaneously.

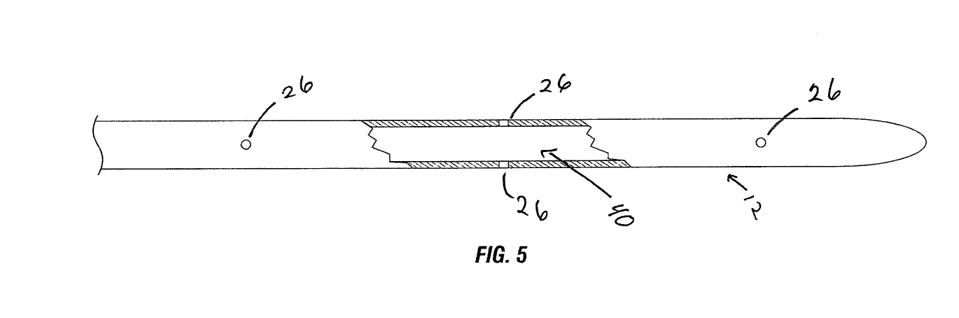

A partial detail-sectional view of wand 12 showing its interior 40 is shown in FIG. 5. This view shows how wand 12 is a hollow cylinder that allows a quantity of fluid to flow therethrough. Also shown are holes 26 illustratively smaller in diameter than the cross section of interior 40 to create a forced spray from holes 26 to dowse bun 6. (See also FIGS. 1 and 2.)

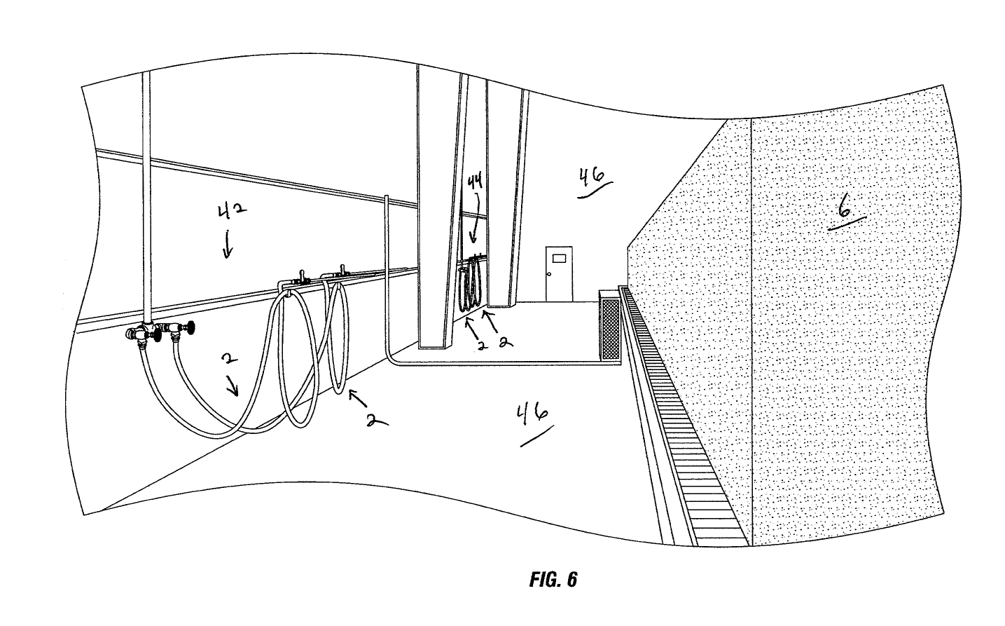

A perspective view of bun room 46 housing a long bun 6 is shown in FIG. 6. This view shows multiple sets of fire suppression systems 2, as indicated by reference numerals 42 and 44. As can be appreciated from this view, foam bun 6 being so long that multiple fire suppression systems can be useful to dowse larger portions of bun 6 at one time.

Another embodiment of the present disclosure includes a portable foam combustion suppression system that includes a wand that may be sized smaller or the same size as the prior embodiments, a shutoff valve, and wand hose. The wand hose may be fluidly coupled to a portable water source, such as a tank, or a permanent water hookup, such as a bib or hydrant. This portable suppression system is designed to be movable to various locations around the facility and/or be deployed at multiple locations where foam is being made. This embodiment is useful in situations where polyurethane foam is being formulated and the chemicals are being mixed and monitored. When an improper mix is detected indicating a potential for internal combustion, the line can be stopped and the bun portion removed. It can be injected with this smaller wand and dowsed immediately before further danger can arise.

Corresponding reference characters indicate corresponding parts throughout the several views. The exemplification set out herein illustrates embodiments of the fire suppression system, and such exemplification is not to be construed as limiting the scope of the fire suppression system in any manner.

What is claimed is:

1. A bun fire suppression system comprising:
a wand comprising shaft and end portions, and having a hollow portion disposed through the shaft portion;
wherein the wand is configured to pierce into a foam bun;
wherein the wand further includes a plurality of holes extending from the hollow portion inside the wand to exterior of the wand;
wherein the plurality of holes in the wand are configured to direct water out and away from the wand in a plurality of directions;
a valve coupled to the wand and in fluid communication with the hollow portion of the wand;
wherein the valve includes a shut-off that selectively stops and releases water flow from the valve to the hollow portion of the wand; and
a hose coupled to the valve opposite the wand;
wherein the hose is configured to also couple to a water source and direct water to the valve.

2. The bun fire suppression system of claim 1, wherein the valve is a ball valve.

3. The bun fire suppression system of claim 1, wherein the wand is configured to be inserted into foam.

4. The bun fire suppression system of claim 1, wherein the wand may be about 80 inches in length.

5. The bun fire suppression system of claim 1, wherein the plurality of holes in the wand are distributed along the wand's shaft.

6. The bun fire suppression system of claim 1, wherein the hose is configured to receive pressurized water up to the valve while the valve is shut off such that when the valve is opened atmosphere inside the hollow portion of the wand is pushed exterior of the wand by the water.

7. The bun fire suppression system of claim 1, further comprising a plurality of wands, each coupled to a separate valve and hose, and all hoses being coupled to the water source so each wand is configured to selectively spray water.

8. The bun fire suppression system of claim 5, wherein the plurality of holes in the wand are configured to expel water from a peripheral circumference of the wand.

9. The bun fire suppression system of claim 1, wherein the wand is configured to thread onto the valve, and wherein the valve is also configured to thread onto the hose.

10. The bun fire suppression system of claim 1, further comprising a hose shut-off spaced apart from the valve shut-off.

11. The bun fire suppression system of claim 1, wherein the plurality of holes are each smaller in diameter than the hollow portion's cross-section.

12. The bun fire suppression system of claim 1, wherein the hose is fluidly coupled to a portable water source.

13. The bun fire suppression system of claim 1, wherein the end of the wand is needle-tipped.

14. A method of dousing an interior portion of a burning foam bun, the method comprises the steps of:
providing a fire suppression system that includes a wand comprising shaft and end portions, and having a hollow portion disposed through the shaft portion, wherein the wand is configured to pierce into a foam bun, wherein the wand further includes a plurality of holes extending from the hollow portion inside the wand to exterior of the wand, wherein the plurality of holes in the wand are configured to direct water out and away from the wand in a plurality of directions, a valve coupled to the wand and in fluid communication with the hollow portion of the wand, wherein the valve includes a shut-off that selectively stops and releases water flow from the valve to the hollow portion of the wand, and a hose coupled to the valve opposite the wand, wherein the hose is configured to also couple to a water source and direct water to the valve;
inserting the shaft of the wand into the interior of the bun;
opening the valve; and
allowing water to spray through the plurality of holes in the wand, away from the wand, and in multiple directions into the foam bun.
